(19) United States
(12) Patent Application Publication
(10) Pub. No.: US 2021/0298973 A1
(43) Pub. Date: Sep. 30, 2021

(54) INFECTIOUS DISEASE ISOLATION ENCLOSURE SYSTEM, METHOD, AND APPARATUS

(71) Applicant: Jeffrey T. Barbosa, Rancho Palos Verdes, CA (US)

(72) Inventor: Jeffrey T. Barbosa, Rancho Palos Verdes, CA (US)

(21) Appl. No.: 17/219,126

(22) Filed: Mar. 31, 2021

Related U.S. Application Data
(60) Provisional application No. 63/003,227, filed on Mar. 31, 2020.

(51) Int. Cl. A61G 7/05; A47C 21/08; A47C 29/00; A61G 10/00; A61G 10/02

(52) U.S. Cl. CPC A61G 7/0526; A47C 21/08; A61G 10/02; A61G 10/005; A47C 29/003

(57) ABSTRACT

An isolation enclosure to contain a person who may have an infectious disease to protect a surrounding population from the infectious disease or to contain a person who may not have an infectious disease to protect the person from a surrounding population who may have the infectious disease. The isolation chamber may be inexpensive, easy to setup, and may be secured to adjacent enclosures. The isolation chamber and adjacent enclosures may comprise the same components.

### CROSS-REFERENCE TO RELATED APPLICATIONS

This application is a non-provisional of, claims the benefit of, and incorporates by reference the subject matter of U.S. provisional patent application Ser. No. 63/003,227, filed Mar. 31, 2020.

### FIELD

The present disclosure relates to an isolation enclosure, in particular to an isolation enclosure to be used in relation to humans who may be infected with an infectious disease or who may need to be protected from an infectious disease.

### BACKGROUND

Infectious diseases may be caused by organisms, such as viruses, bacteria, fungi, parasites, and, potentially, by malformed prions. Some infectious diseases can be passed from one person, who may be referred to herein as a “reservoir”, to another person, for example, through bodily fluids or materials. For example, an infected person who is a reservoir and who is also contagious may cough, vomit, flush a toilet, emit blood, disturb dried material containing an infectious agent, or otherwise aerosolize or release an infectious agent into the air and or onto a surrounding environment, e.g., as droplets, particles, or material. The released droplets, particles, or material may be a route of transmission for the infectious disease (not all bodily fluids or materials are routes of transmission for all infectious diseases).

Infectious diseases may be difficult to distinguish from one another, based solely on symptoms. In addition, some people may be infected with an infectious disease but present no symptoms, may present a subset of typical symptoms, or may present atypical symptoms. Symptoms of different infectious diseases may overlap, which may make it difficult to distinguish one infectious disease from another, without tests. Test may include, for example, microbial culture, microscopy, biochemical tests, polymerase chain reaction (“PCR”), and metagenomic analysis.

Tests to distinguish different infectious diseases from one another may not be readily available or may be expensive. People may come to a medical facility, such as a hospital, clinic or the like, or may be at home or in the community, with an unknown status relative to an infectious disease.

Treatment of infectious diseases may range from treating symptoms, to treating the underlying infection, to inoculation against the infectious disease. Treatment may be expensive or unavailable. During a widespread outbreak of an infectious disease, supply of resources to treat both “regular” disease and the infectious disease may not be able to meet demand for such resources.

Infectious diseases may have a rate of transmission from reservoirs to uninfected persons which exceeds a rate of removal of the reservoirs from the population. In addition to inoculation of potential reservoirs against an infectious disease, removal of the reservoirs from the population may occur through recovery, mortality, and isolation of people who are reservoirs.

Consequently, it may be desirable or necessary to isolate a person in an enclosure, before it is known whether the person carries an infectious disease. However, isolation enclosures may be expensive, difficult to setup, difficult to clean, and/or may not allow occupants to move or engage in a range of normal bodily functions.

### BRIEF DESCRIPTION OF THE DRAWINGS

FIG. 1 illustrates an example of an isolation enclosure incorporated with teachings of the present disclosure, according to some embodiments.

FIG. 2 illustrates an example of an isolation enclosure incorporated with teachings of the present disclosure, according to some embodiments.

FIG. 3 illustrates an example of an isolation enclosure and an adjacent enclosure incorporated with teachings of the present disclosure, according to some embodiments.

FIG. 4 illustrates an example of an isolation enclosure and an adjacent enclosure incorporated with teachings of the present disclosure, according to some embodiments.

FIG. 5 illustrates an example of a fastener incorporated with teachings of the present disclosure, according to some embodiments.

FIG. 6 illustrates an example of a base and a frame of an isolation enclosure incorporated with teachings of the present disclosure, according to some embodiments.

FIG. 7 illustrates an example of a wireframe suspended isolation enclosure incorporated with teachings of the present disclosure, according to some embodiments.

FIG. 8 illustrates an example of a wireframe suspended isolation enclosure incorporated with teachings of the present disclosure, according to some embodiments.

FIG. 9 illustrates an example of an air pump and or air vent incorporated with teachings of the present disclosure, according to some embodiments.

FIG. 10 illustrates an example of an access port into an isolation enclosure incorporated with teachings of the present disclosure, according to some embodiments.

FIG. 11 illustrates the example of the access port into the isolation enclosure of FIG. 10 with a cross section and incorporated with teachings of the present disclosure, according to some embodiments.

FIG. 12 illustrates an example of a flexible glove form of an isolation enclosure incorporated with teachings of the present disclosure, according to some embodiments.

FIG. 13 illustrates an example of an isolation enclosure, a push-through airtight connector, a power supply, a flexible glove form, and a sensor suite incorporated with teachings of the present disclosure, according to some embodiments.

### DETAILED DESCRIPTION

In addition to other locations, defined terms may be found at the end of this Detailed Description.

In overview, this disclosure relates to an enclosure (“isolation enclosure”) to isolate a person who may have an infectious disease from the surrounding population and infrastructure; in an embodiment, the isolation enclosure may isolate a non-infected person (or person with unknown infected status) from others in the environment who may be infectious. The surrounding population and infrastructure may comprise, for example, a medical facility and staff, members of a household or living area, volunteers at a shelter, and the like. The isolation enclosure may be simple to fabricate, low cost, easy to clean, and may allow the occupant to move and engage in a range of bodily functions.

The isolation enclosure may be formed of or comprise materials such as plastic, nylon, polycarbonate, polyester, polyethylene, polypropylene, polyurethane, polyvinyl chloride (“PVC”), tent poles, including aluminum or fiberglass tent poles, gromets, zippers (including zippers with interlocking teeth and press-seal zippers similar to Ziplock™ zippers), loop-and-hook fasteners, woven fabrics, coated woven fabrics, laminated fabrics, woven and non-woven air filter materials, air pumps, air filters (including high-efficiency particulate air (“HEPA”) filters), ultra-violet light emitters, ozone generators, particle sensors, oxygen sensors, carbon dioxide sensors, temperature sensors, and the like.

The isolation enclosure may be assembled by staff of medical centers, volunteers, family members, or by persons. Those who assemble the isolation enclosure may not have specialized training. The isolation enclosure may be assembled on or around an existing structure, such as a bed, a mattress, a hospital bed, a cot, or the like. Isolated people may need to be in an isolation enclosure for a significant period of time, such as days, weeks, or months. Isolated people may need to engage in normal bodily functions, such as excretion of waste. The isolation enclosure may allow an isolated person to sit up, move, move to an adjacent enclosure, and engage in at least a subset of normal bodily functions. The isolation enclosure and bedding and equipment in it may be cleaned. The isolation enclosure may comprise a drain to allow selective release of accumulated liquids and debris from an interior of the isolation enclosure. The isolation enclosure may be cleaned with, for example, soap and water, ultra-violet light, ozone, bleach, iodine, alcohol, disinfectants, and the like.

The isolation enclosure may comprise, for example, a base, a frame, and an enclosure envelope.

The base may comprise, for example, a sheet of plastic or the like. The base may be placed beneath or on top of, for example, an existing structure, such as a mattress or pad (hereinafter, “mattress”).

The base may comprise securements for the frame or “frame securements”, such as grommet holes, flanges, couplings, or the like, in or proximate to corners and edges of the base. The frame securements may accommodate or receive ends of the frame. The frame securements may be spaced regularly, to accommodate use of the base and frame with existing structures of different sizes. In an embodiment, the base may have a shape of a rectangle. In an embodiment, the base may comprise edges at the perimeter, wherein the edges extend upward and form a pan. The base may comprise a drain; the drain may allow an isolation enclosure to be washed and or flooded with a liquid or gas and for the liquid or gas to exit through the drain. In an embodiment, the base may comprise one continuous structure or a plurality of sub-structures joined together. The base may have a size approximately the size of an existing structure, such as a bed, a hospital bed, a cot, or the like. The base may be sized to accommodate a large existing structure, with overlap occurring among sub-structures of the base when it is used with smaller existing structures. The base may comprise breaks in its structure, wherein the breaks allow sub-structures of the base to be removed or overlapped with other sub-structures of the base, to reduce the base in size. The base may be flexible, to accommodate change in the shape of the existing structure, such as, for example, a hospital bed with a jointed or tilt-up section. In an embodiment, the base may comprise accordion folds, to allow the base to bend.

In an embodiment, the base may be formed from multiple separate strips (“strips”), which may be arranged in a matrix. In an embodiment, each of or individual of the strips may comprise frame securements, such as grommet holes, or other securement structures (“frame securements”). The frame securements may accommodate or receive ends of the frame. The frame securements may be spaced regularly, to accommodate use of the strips and frames with existing structures of different sizes. In an embodiment, multiple strips may be arranged with a first set of strips along the x-axis and a second set of strips along the z-axis, to form a shape corresponding to an existing structure. In an embodiment, the frame securements of strips may be aligned and the ends of a frame or another structure may be passed through the frame securements to secure the strips in the desired shape. In an embodiment, the strips may comprise perforations or weakenings, wherein the weakenings would allow portions of the strips to be removed, to reduce the size of the strips. The strips may be flexible, to accommodate change in the shape of the existing structure, such as, for example, a hospital bed with a jointed or tilt-up section.

The frame may comprise poles, such as tent poles, PVC poles, and the like. The poles may comprise, for example, vertically oriented poles, horizontally oriented poles, and or poles which bend to form arches. The vertically oriented poles and or arches may be secured to frame securements in the base. The horizontally oriented poles may be secured to tops of the vertically oriented poles, such as at junctions. A set of vertically oriented poles and one or more horizontally oriented poles or an arch may form one or more inverted “U” or “C” structures. One or more “U” or “C” structures may span the short axis of an existing structure (e.g. the z-axis), such as a mattress. One or more “U” or “C” structures may span all or part of the long axis of an existing structure (e.g. the x-axis of the existing structure). One or more “U” or “C” structures may be secured to one another, for example, by one or more beams. Beams may be secured to a top of the “U” or “C” structures. Beams may be flexible, to allow the beams to be curved, such as when an existing structure, such as a bed, is jointed and the base and frame also bends. Beams may be secured to a center and/or ends of the “U” or “C” structures. The “U” or “C” structure may be flexible, to allow the “U” or “C” structure to be curved, such as when an existing structure, such as a bed, is jointed and the base and frame also bends and the “U” or “C” structure spans the long axis of the existing structure and would therefore also need to bend.

The frame may comprise, for example, two to four poles along each side of the long axis of the base, for a total of, for example, four to eight poles. When, for example, a total of four poles are used (two per side), the four poles may be located at corners of the base. When, for example, more than four total poles are used, poles may be located along a perimeter of the base. When poles are located along a perimeter of the base, one or more poles (or sets of poles, such as a “U” or “C” structure) may be located at or past a bending location of the existing structure, such that the poles, “U” or “C” structure, beams and the like do not interfere with bending. The frame may comprise arches arranged in a dome or a partial dome structure.

The frame and/or beams may comprise mounts to secure the frame and/or beams to a ceiling, a drop-ceiling frame, or the like.

The frame and/or beams may comprise, for example, poles which bend, forming one or more “C” structures or arches, with the open side of the “C” facing downward.

The frame may comprise pivots, to allow the frame to bend. The frame may be formed of flexible materials, to allow the frame to bend.

The frame may comprise straps to secure the frame to, for example, bed posts or the like.

The enclosure envelope may comprise one or more sheets of a low cost, pliant, and/or flexible material which may filter out or block passage of an infectious agent, such as, for example, plastic, latex, silicone, urethane, paper, coated paper, woven or non-woven fabrics, filter material (such as an “n95” filter material), and the like. The sheets may be formed in a rectangular structure or into a structure which may fit within the frame. In an embodiment, the sheet may fit around the frame. The sheets may be formed in a tubular shape, wherein the tubular shape may be conformed to a rectangular frame or a curved frame. The sheets may be provided with excess material, to allow the enclosure envelope to extend, for example, to the floor or to extend outward, beyond the frame, to allow the enclosure envelope to be secured to an adjacent enclosure (discussed below), or to allow the enclosure envelope to be secured to a frame which changes in size.

The sheets may comprise fasteners to secure separate sheets together, to secure ends of one sheet together, to secure sheets to other components, and to form a door, entry, or the like between two sheets. Fasteners may be secured to edges of sheets or in other areas. Fasteners may comprise structural fasteners capable of resisting forces which might otherwise open the enclosure envelope; for example, structural fasteners may comprise zippers, laces, hook and loop fasteners, and the like. In embodiments, structural fasteners may not provide a reliable seal against passage of air and may not prevent communication of infectious diseases. Fasteners may comprise air-seal fasteners; for example, air-seal fasteners may comprise press-seal fasteners, similar to Ziplock™ fasteners. In embodiments, air-seal fasteners may not be able to resist forces which might otherwise open the enclosure envelope. In embodiments, a fastener may be coated in rubber or polyvinyl chloride (“PVC”), may have a reverse coil structure, may be referred to as a “water resistant zipper” and may act as both a structural fastener and as an air-seal fastener.

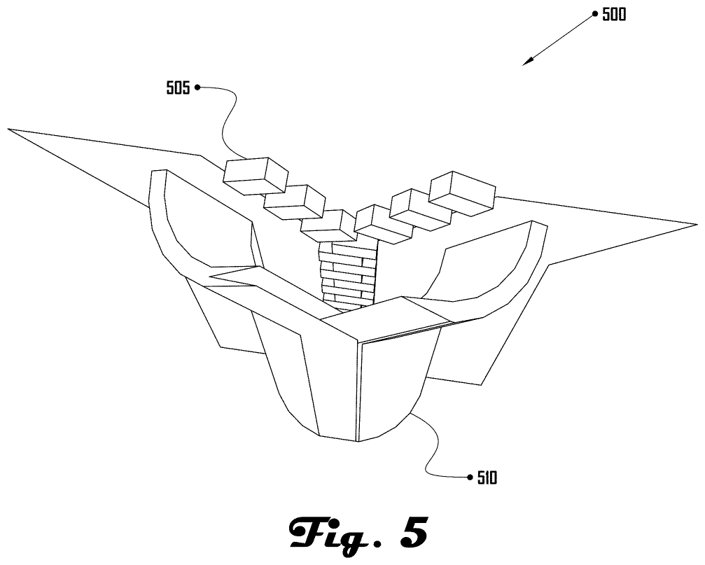

Fasteners may comprise a set, comprising both structural fasteners and air-seal fasteners, arranged such that the structural fasteners support and maintain the structural integrity of the enclosure envelope, while the air-seal fasters isolate the interior of the enclosure envelope from the surrounding environment. An example of a set of fasteners comprising both structural fasteners and air-seal fasteners is illustrated and discussed in relation to FIG. 5.

The enclosure envelope may comprise ports and/or push through airtight connectors, through which conduits, hands, arms, or the like (depending on size) may pass, while obstructing or filtering the passage of air. Examples of conduits include, for example, ventilator conduits, oxygen or air conduits, intravenous fluid lines, and conduits for sensors, such as blood pressure sensors, EKG sensors, and the like. In embodiments, an access port comprising or in the form of a flexible glove may comprise a form to accommodate a hand, arm or the like (e.g. with a glove or mitten shape) of a flexible or pliant material, such as rubber, latex, urethane, fabrics, and the like; the flexible glove form may be reversible, such that a caregiver may insert the caregiver's hand into the glove and allow the caregiver to interact with the patient, or the patient may insert a patient's hand into the glove and allow the patient to interact with the exterior world, without opening the enclosure envelope.

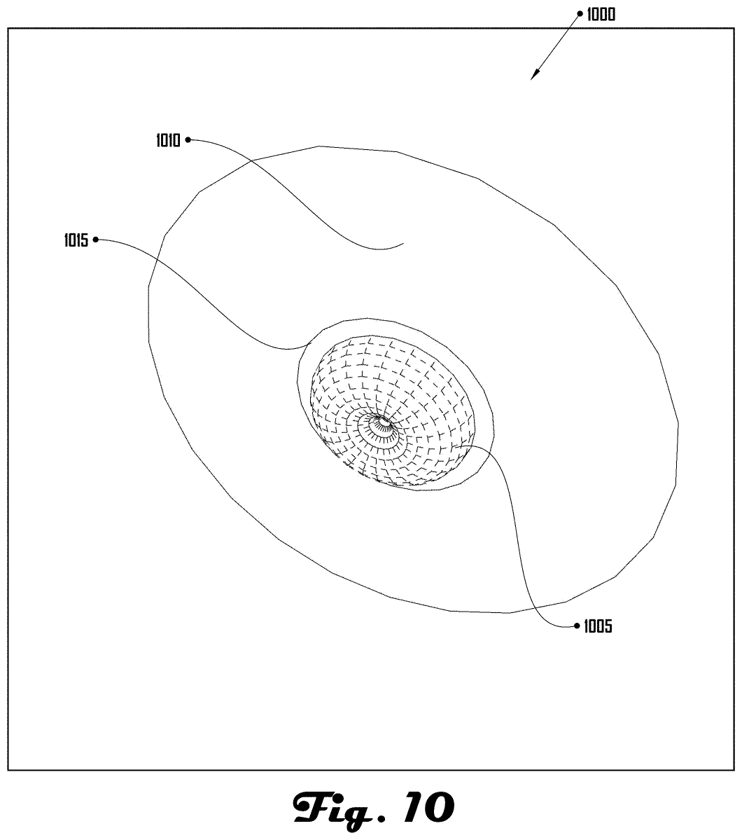

An example of one or more access ports may comprise and/or support one or more channels. The channels may be formed of plastic, rubber, latex, silicone, urethane, or the like. The channels may have a toroidal or “donut” shape, with an interior volume (the volume of the “donut”) and a central passage (the “hole” in the “donut”). The interior volume of the toroid may be filled with a liquid or air. The liquid or air may be at higher pressure than standard atmospheric pressure. The liquid or air may exert pressure on the central passage. Conduit(s), hands, arms, and the like, depending on the size of the port and pressure in the interior volume of the toroid, may be pass through the central passage. Examples of access ports such as push through airtight connectors and flexible glove forms are illustrated in FIG. 10 through FIG. 13.

The isolation enclosure may comprise a top or ceiling (“top”). The top may be formed of the same material as the enclosure envelope. The top may be formed of the same material and in the same manner as the base. The top may comprise mounts to secure the top to a ceiling, to the frame, or the like. The top may comprise accordion folds, to allow the top to bend.

The isolation enclosure may be mobile, such as when secured to an external structure which comprises wheels, such as a hospital bed.

The isolation enclosure may comprise or be secured to an air pump. The air pump may pump air into or out of the enclosure envelope. The air pump may obtain power from, for example, a wall outlet, a battery pack, and the like. The air pump may comprise or be coupled to an alarm, wherein the alarm will be triggered if the air pump loses power. The air pump may provide the enclosure envelope with positive air pressure (e.g. air pressure higher than that of external air pressure) or negative air pressure (e.g. air pressure lower than that of external air pressure).

Air pumped into the enclosure envelope or allowed to escape from the enclosure envelope, such as through an air vent, may be filtered, such as through a high-efficiency particulate air (“HEPA”) filter. A particle counter sensor may be included in the air vent and or in the enclosure envelope. The particle counter may count particles, such as particles of dust, particles of fluid, and the like. The particle counter may be used to monitor the status of filters, such the HEPA filter, as well as air quality within the enclosure envelope.

In addition to the particle counter sensor, the enclosure envelope may comprise an oxygen sensor and/or a carbon-dioxide sensor. The sensors may be coupled to alarms and or a control system, wherein the alarms may be triggered on occurrence of a dangerous or undesirable condition, such as a lack of oxygen, an excess of carbon-dioxide, or improper functioning of a sensor.

The enclosure envelope may comprise an ultra-violet light emitter, an ozone generator, and the like. Such components may be used to clean or sterilize an interior of the enclosure envelope, a HEPA filter, or the like. Such components may be used when the enclosure envelope is not occupied. Such components may be coupled to a control system.

The isolation enclosure may comprise or be secured to one or more adjacent enclosures. The adjacent enclosures may comprise elements of the isolation enclosure. Adjacent enclosures may comprise, for example, a room or enclosure, a passage, or the like. Adjacent enclosures may, for example, allow a patient to change position, stand, or stretch, allow the patient and/or isolation enclosure to be cleaned, allow the patient to exit the isolation enclosure to excrete waste (feces, urine, vomit, and the like), allow a party, such as a caretaker, doctor, or the like, to interact with the patient with reduced exposure risk to the interacting party and/or to the surrounding population.

The adjacent enclosure may be secured to an isolation enclosure at, for example, a location of the isolation enclosure which does not bend. For example, if an isolation enclosure is used with a hospital bed and/or mattress which bends at the one-third point (or the like), the adjacent enclosure may be located past the location where the isolation enclosure bends.

The adjacent enclosure may be secured to an isolation enclosure at, for example, a geometric location of a frame of the isolation enclosure which maintains a consistent spatial location when the isolation enclosure bends.

The adjacent enclosure may comprise a frame, a base, a frame, and an enclosure envelope.

The frame of the adjacent enclosure may be separate from a frame of an isolation enclosure. The frame of the adjacent enclosure may use elements of the frame of the isolation enclosure. One or more elements of the frame of an adjacent enclosure may be secured to a frame of the isolation enclosure, to the frame of another adjacent enclosure, and/or to other structures, such as a bed frame. The base of an adjacent enclosure may be formed in a similar manner to the base of the isolation enclosure and may be secured to the frame of the adjacent enclosure in a similar manner to the frame of the isolation enclosure. The base of the adjacent enclosure may comprise a drain. An enclosure envelope of the adjacent enclosure may be within the frame of the adjacent enclosure or may be around the frame of the adjacent enclosure.

The enclosure envelope of the adjacent enclosure may be secured to the enclosure envelope of the isolation enclosure, such as using fasteners as described herein. The fasteners of the adjacent enclosure may transfer forces, such as forces from the enclosure envelope of the isolation enclosure, across the frame of the adjacent enclosure.

The enclosure envelope of the isolation enclosure may comprise openings, such as flaps, which allow the enclosure envelope of the isolation enclosure to be secured to the enclosure envelope and/or base and/or top of the adjacent enclosure. A face of the adjacent enclosure may face the isolation enclosure; such a face may comprise an opening, bordered with fasteners as described herein. The fasteners on such face may be secured to corresponding fasteners in a flap or opening of the isolation enclosure.

The adjacent enclosure may comprise a door. The door may comprise a hinged door and/or may comprise a flap with fasteners as describe herein.

One or more adjacent enclosures may be secured together to form a larger structure.

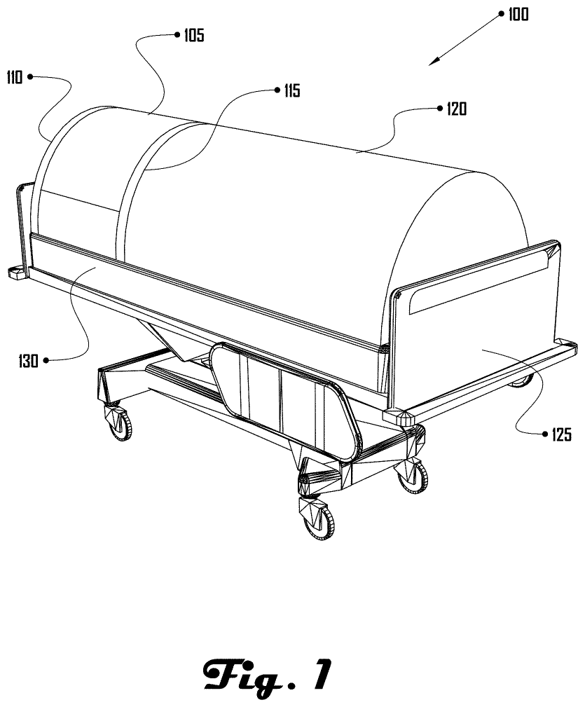

FIG. 1 illustrates an example of an isolation enclosure and an adjacent enclosure incorporated with teachings of the present disclosure, according to some embodiments.

The isolation enclosure may comprise or be accompanied by a control system. The control system may control and or be coupled to, for example, the air pump, air filters, particle sensors, oxygen sensors, carbon dioxide sensors, other sensors, ultraviolet light emitters, ozone emitters, lights, and an uninterruptible power supply.

Embodiments of the operations described herein, such as by a control system, may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions. USB (Universal serial bus) may comply or be compatible with Universal Serial Bus Specification, Revision 2.0, published by the Universal Serial Bus organization, Apr. 27, 2000, and/or later versions of this specification, for example, Universal Serial Bus Specification, Revision 3.1, published Jul. 26, 2013. PCIe may comply or be compatible with PCI Express 3.0 Base specification, Revision 3.0, published by Peripheral Component Interconnect Special Interest Group (PCI-SIG), November 2010, and/or later and/or related versions of this specification.

As used herein “releasable”, “connect”, “connected”, “connectable”, “disconnect”, “disconnected,” and “disconnectable” refers to two or more structures which may be connected or disconnected, generally without the use of tools (examples of tools including screwdrivers, pliers, drills, saws, welding machines, torches, irons, and other heat sources) or with the use of tools but in a repeatable manner (such as through the use of nuts and bolts or screws). As used herein, “attach,” “attached,” or “attachable” refers to two or more structures or components which are attached through the use of tools or chemical or physical bonding, but wherein the structures or components may not generally be released or re-attached in a repeatable manner. As used herein, “secure,” “secured,” or “securable” refers to two or more structures or components which are connected or attached. Phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It is intended that the terminology used herein be interpreted in its broadest reasonable manner, even though it is being used in conjunction with description of certain examples of the technology. Although certain terms may be emphasized herein, any terminology intended to be interpreted in a restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “coupled,” or any variant thereof means any coupling, either direct or indirect between two or more elements; a coupling between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list. References may be made herein to modules, routines, and subroutines; generally, it should be understood that a module or routine is a software program executed by computer hardware and that a subroutine is a software program executed within a module or routine. However, modules or routine discussed herein may be executed within another module or routine and submodules or subroutines may be executed independently (modules or routines may be submodules or subroutines and visa versa).

As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination.

FIG. 1 illustrates an example of isolation enclosure 100 incorporated with teachings of the present disclosure, according to some embodiments. Hoop 110 and hoop 115 hold enclosure envelope 105 and enclosure envelope 120 above a person. Hoop 110 and hoop 115 may comprise flexible poles. Hoop 110 and hoop 115 may be constructed out of, for example, aluminum, iron, steel, brass, bronze, fiberglass, carbon fiber, or, in the case of compressed air, bladders or balloons within sleeves. flexible Enclosure envelope 105 may be transparent while enclosure envelope 120 may be opaque. One or more of enclosure envelope 105 and or enclosure envelope 120 may be a breathable material, such as a mesh, cloth, filter material, or the like.

Isolation enclosure 100 may be rapidly deployed around a person on, for example, a bed, such as on mattress 130 within bed frame 125. An air pump and filter, as discussed further herein, may pump air into our out of isolation enclosure 100.

Isolation enclosure 100 may comprise sensors, push through airtight connectors, glove boxes, an access port, a control module, and or a power supply as discussed further herein.

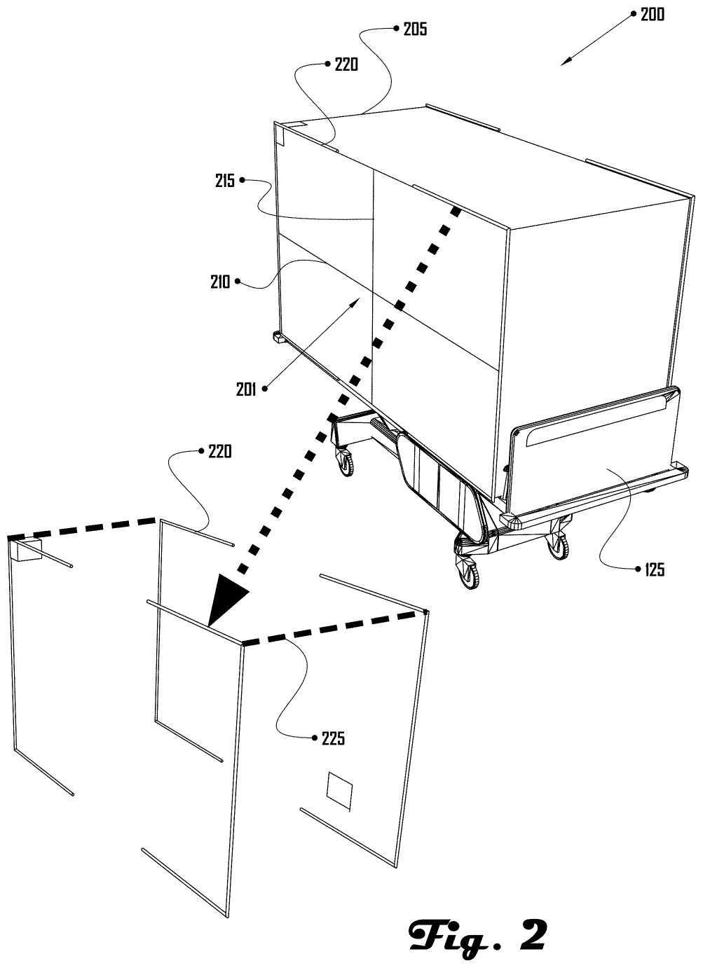

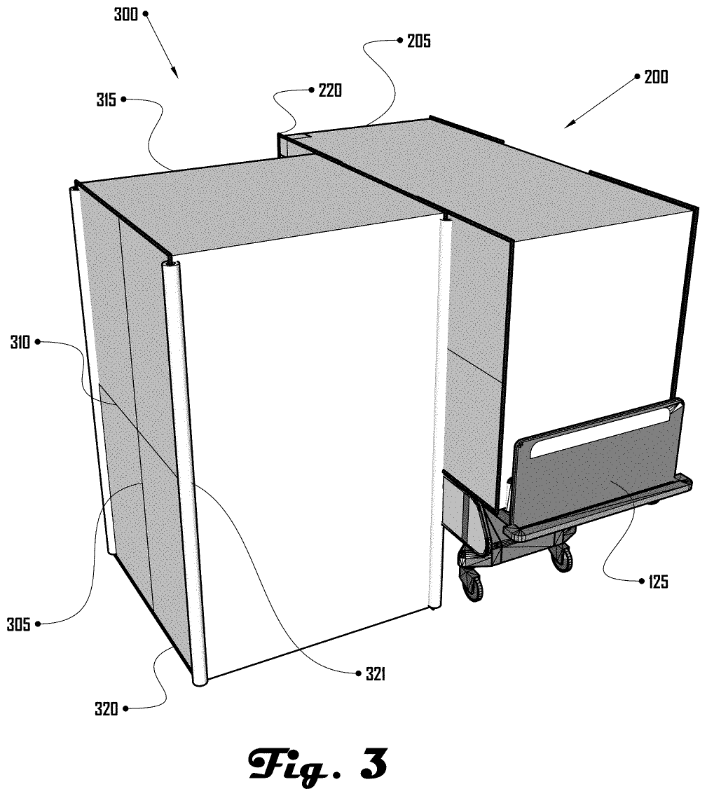

FIG. 2 illustrates an example of isolation enclosure 200 incorporated with teachings of the present disclosure, according to some embodiments. Isolation enclosure 200 may comprise, for example, isolation envelope 205 within, around, or supported by frame 220. Frame 220 may comprise cantilever 220. Cantilever 220 may be secured beneath a mattress and or to a frame of bed 125, as discussed further herein. Cantilever 220 may comprise removeable cross-beam 225. Ends of cantilever 220 may slide into a tubes, such as tubes 321 (discussed in relation to FIG. 3).

Isolation envelope 205 may comprise one or more sheets of pliant or flexible material to filter or block passage of an infectious agent; wherein the one or more sheets of pliant or flexible material comprise at least one of plastic, paper, coated paper, a woven fabric, a filter material, a laminated material or the like; wherein the one or more sheets are shaped to fit within frame 220 or around frame 220. The one or more sheets may be formed in a tubular shape, such as a tube sized to fit around or within frame 220. The one or more sheets may comprise fasteners to secure a first of the one or more sheets to a second of the one or more sheets. The fasteners may comprise a structural fastener and an air-seal fastener. The structural fastener maintain the structural integrity of the enclosure envelope and may resist ambient forces tending to open the isolation enclosure system. The structural fastener comprises at least one of a zipper, a lace, or a hook and loop fastener. The air-seal fastener may not resist ambient forces tending to open the isolation chamber and or does not maintain the structural integrity of the enclosure envelope but resists passage of air between the one or more sheets. The air-seal fastener may comprise a press-seal fastener. The fasteners may comprise a set of structural fasteners and air-seal fasteners.

Enclosure envelope 200 may comprise opening 201 to allow ingress and egress from the enclosure envelope; wherein opening 201 is formed by or comprises a fastener. Examples of fasteners are illustrated in FIG. 2 at fastener 215 and fastener 210, which may form opening 210. For example, one zipper may run from top to bottom of fastener 215, while two zippers, one on either side of fastener 215, form fastener 210. Fasteners may be formed into or attached to enclosure envelope 200, such as through heat bonding, glue, stitching, catalytic formation of cross-chains, and the like.

Isolation enclosure 200 may comprise sensors, push through airtight connectors, flexible glove forms, an access port, ultraviolet light emitters, ozone emitters, a control module, and or an uninterruptible power supply, as discussed further herein.

FIG. 3 illustrates an example of isolation enclosure 200 and an adjacent enclosure 300 incorporated with teachings of the present disclosure, according to some embodiments.

Adjacent enclosure 300 and isolation enclosure 200 may be constructed of many of the same materials and of the same base components. Adjacent enclosure 300 may be isolation enclosure 200 rotated ninety degrees. Adjacent enclosure may comprise frame 320, which may be substantially similar to frame 220. Frame 320 may be within tubes 321. Tubes 321 may also be used in relation to isolation enclosure 200, e.g. when horizontally oriented. Adjacent enclosure 300 may comprise fastener 310 and fastener 305, which may be substantially similar to fastener 215 and fastener 210.

Opening 201 of isolation enclosure 200 may be secured to a corresponding opening in adjacent enclosure 300.

Thereby, one structure may be used to accommodate a horizontally oriented person and or a vertically oriented person within one or both of a horizontally and or a vertically oriented iteration of a common structure. One or both of the isolation enclosure and or the adjacent enclosure may accommodate a toilet or other facilities for elimination of waste. One or both of the isolation enclosure and or the adjacent enclosure may allow an increased range of motion of a person within one or both of isolation enclosure and or adjacent enclosure. In this way, a set of low cost and easy to assemble components may be used in a wide range of configurations, bringing much needed relief and greater physical mobility to persons in difficult circumstances.

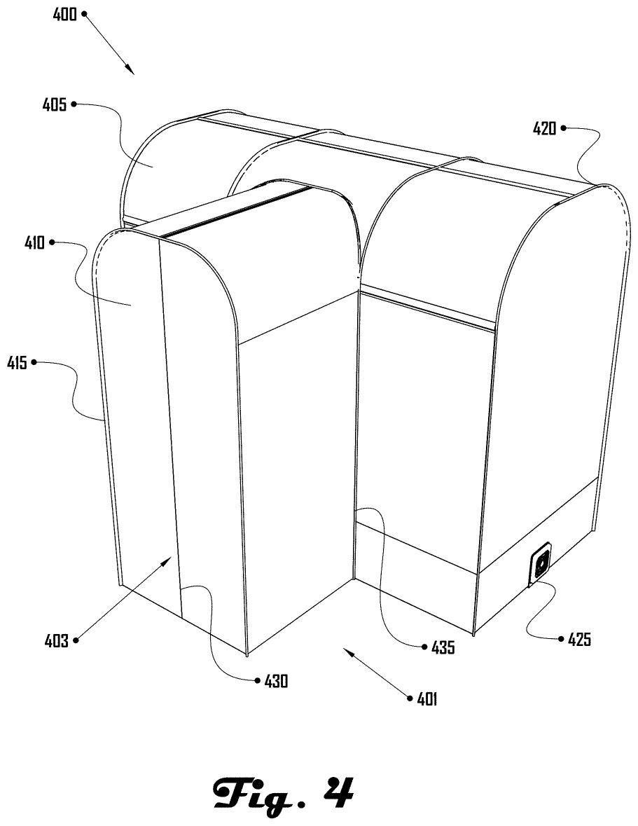

FIG. 4 illustrates an example of isolation enclosure 400 and adjacent enclosure 401 incorporated with teachings of the present disclosure, according to some embodiments. Isolation enclosure 420 may comprise frame 420; adjacent enclosure 401 may comprise frame 415. Isolation enclosure 400 and adjacent enclosure 401 may share components of a frame, such as at shared frame 435. Frame 420 and 415 may comprise flexible poles which form arches. Isolation enclosure 400 may comprise isolation envelope 405. Adjacent enclosure 401 may comprise isolation envelope 415. Adjacent enclosure 401 may comprise fastener 430 in or forming opening 403 of adjacent enclosure 401. Fastener 430 may be released, to allow access to an interior of adjacent enclosure 401 and isolation enclosure 400 and to allow the opening of adjacent enclosure 401 to be secured.

In the illustrated embodiment, isolation enclosure 400 and adjacent enclosure 401 are not the identical structure. Isolation enclosure 400 and adjacent enclosure 401 may be separable. Isolation enclosure 400 may be used on its own. Isolation enclosure 400 may comprise an opening which may be closed with a fastener. The opening in isolation enclosure 400 may be opened and adjacent enclosure 401 secured to isolation enclosure 400 at the location of such opening, as illustrated in FIG. 4. Isolation envelope 415 of adjacent enclosure 401 may span to isolation enclosure 400.

Isolation enclosure 400 is further illustrated as comprising air pump and air filter 425. Examples of air pumps and air filters are discussed further herein.

A frame of an isolation enclosure may comprise one or more arches in a dome or semi-dome configuration.

FIG. 5 illustrates an example of fastener 500 incorporated with teachings of the present disclosure, according to some embodiments. For example, FIG. 5 illustrates an example of a set of fasteners comprising both structural fasteners 505 and air-seal fasteners 510. The structural fasteners 505 may comprise zipper fasteners with interlocking teeth; a slide-engagement mechanism (not shown) may facilitate engagement of the interlocking teeth. The teeth may be formed in two interlocking coils. The air-seal fasteners 510 may comprise press-seal fasteners, such as a male projection which fits into a corresponding female channel. As illustrated in FIG. 5, the zipper or structural fasteners 505 may be on the edges of a first sheet and a second sheet, while the air-seal fasteners may be located a distance back from the edges of the first sheet and the second sheet. A first side of the air-seal fastener may be secured to the sheet on a portion of material which projects out from the sheet and allows the first side of the air-seal fastener to span across the zipper fasteners (when they are engaged) to a second side of the air-seal fastener. The second side of the air-seal fastener may be secured to the sheet further from the edge of the sheet than the zipper or structural fastener. The press-seal fasteners may be engaged, such as by inserting the male projection into the female channel. Engagement of the press-seal fasteners may be facilitated by, for example, a slide-engagement mechanism (not shown). As discussed herein, in embodiments, a fastener may be coated in or comprise rubber or polyvinyl chloride (“PVC”), may have a reverse coil structure, may be referred to as a “water resistant zipper” or “water resistant fastener”, and may act as both a structural fastener and as an air-seal fastener.

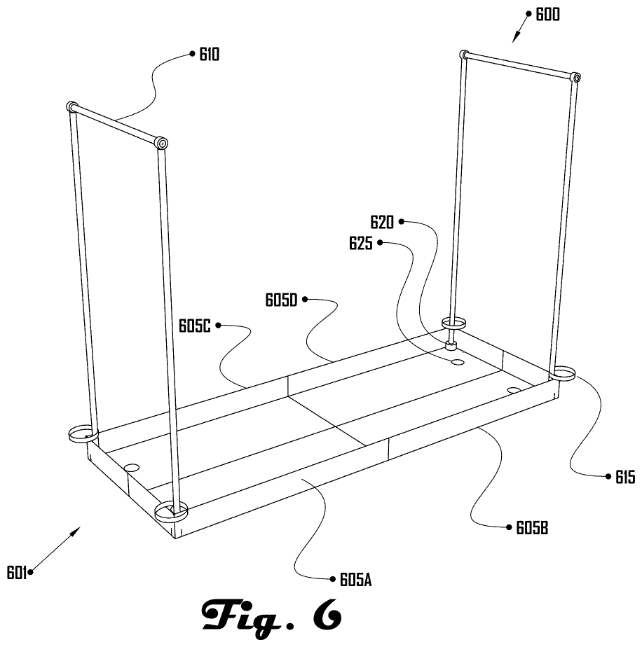

FIG. 6 illustrates an example of base 601 and frame 600 of an isolation enclosure incorporated with teachings of the present disclosure, according to some embodiments. As discussed herein, base 601 may have a shape of a rectangle. In an embodiment, the base may comprise edges at the perimeter, wherein the edges extend upward and form a pan. The base may comprise one or more drain 625. Drains may be used when cleaning an isolation enclosure, such as by washing or flooding the isolation enclosure with a gas or liquid, wherein the gas or liquid may exit through the drain. The drain may comprise a threaded plug. In the example embodiment illustrated in FIG. 6, base 601 comprises a plurality of sub-structures, 605A-605D, which overlap or which may be joined together. The base may be sized to accommodate a large existing structure, with overlap occurring among sub-structures 605A-605D of base 601 when it is used with smaller existing structures. As discussed herein, base 601 may be flexible, to accommodate change in the shape of the existing structure, such as, for example, a hospital bed with a jointed or tilt-up section. In an embodiment, base 601 may comprise accordion folds (not illustrated), to allow the base to bend.

Base 601 may comprise frame securements 620, such as grommet holes or flanges, in or proximate to corners and edges of base 601. Frame securements 620 may accommodate, receive, or hold ends of the frame. Frame securements 620 may be spaced regularly, to accommodate use of base 601 and frame 600 with existing structures of different sizes.

Frame 600 may comprise poles 610, such as tent poles, PVC poles, and the like discussed herein. The poles may comprise, for example, vertically oriented poles and horizontally oriented poles. The vertically oriented poles may be secured to frame securements 620 or in base 601. The horizontally oriented poles may be secured to tops of the vertically oriented poles, such as at junctions. Horizontally oriented poles may be referred to as “beams”. A set of vertically oriented poles and one or more beams may form one or more inverted “U” or “C” structures. One or more “U” or “C” structures may span the short axis of an existing structure (e.g. the z-axis), such as a mattress. One or more “U” or “C” structures may span all or part of the long axis of an existing structure (e.g. the x-axis of the existing structure). One or more “U” or “C” structures may be secured to one another, for example, by one or more joists. Beams may be secured to a top of the “U” or “C” structures. Beams or joists may be flexible, to allow the beams to be curved, such as when an existing structure, such as a bed, is jointed and the base and frame also bends. The “U” or “C” structure may be flexible, to allow the “U” or “C” structure to be curved, such as when an existing structure, such as a bed, is jointed and the base and frame also bends and the “U” or “C” structure spans the long axis of the existing structure and would therefore also need to bend. As illustrated in FIG. 2, pole 610 may comprise cantilevers which are “U” or “C” structures, though rotated 90 degrees relative to the “U” or “C” structures illustrated in FIG. 6 and with one side of the rotated “U” or “C” running parallel to a bed or other existing structure which may lie within base 601.

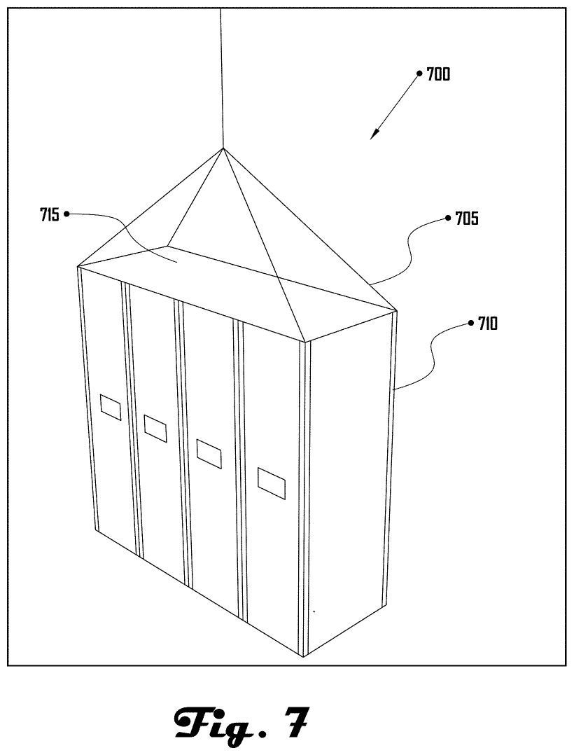

In the example illustrated in FIG. 7, frame 610 may comprise frame straps 615 to secure frame 610 to, for example, bed posts or the like. Frame straps 615 may be integrated into an isolation envelope, such as by being glued, attached, or otherwise secured to an interior and an exterior of sheets of the isolation envelope in a location where frame straps 615 pass through the isolation envelope.

FIG. 7 illustrates an example of a wireframe suspended isolation enclosure 700 incorporated with teachings of the present disclosure, according to some embodiments. In the illustrated example, wireframe supported isolation enclosure 700 comprises isolation enclosure 710, roof 715, and wireframe 705. Wireframe 705 may attach isolation enclosure 710 to a ceiling, to a drop ceiling, to a fixture in a space around isolation enclosure 710. Roof 715 may be rigid and may thereby allow isolation enclosure 710 to be held other than at corners of isolation enclosure and to nonetheless maintain a generally rectangular shape, e.g. to be held by fewer than four points.

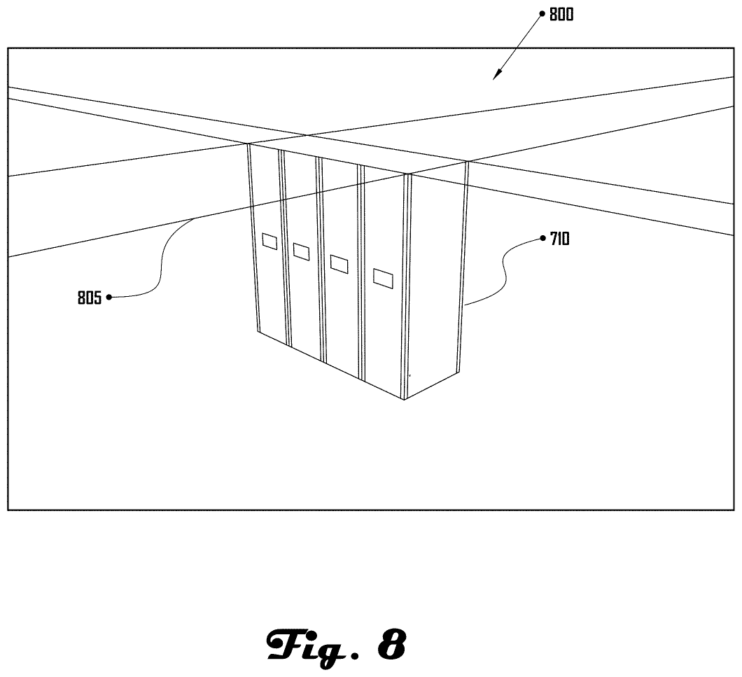

FIG. 8 illustrates an example of a wireframe suspended isolation enclosure 800 incorporated with teachings of the present disclosure, according to some embodiments. In the illustrated example, wireframe supported isolation enclosure 800 comprises isolation enclosure 710, and wireframe 805. Wireframe 805 may attach isolation enclosure 710 to a ceiling, to a drop ceiling, to one or more fixtures in a space around isolation enclosure 710. Wireframe 805 may be secured to top corners and or top edges of isolation enclosure 710.

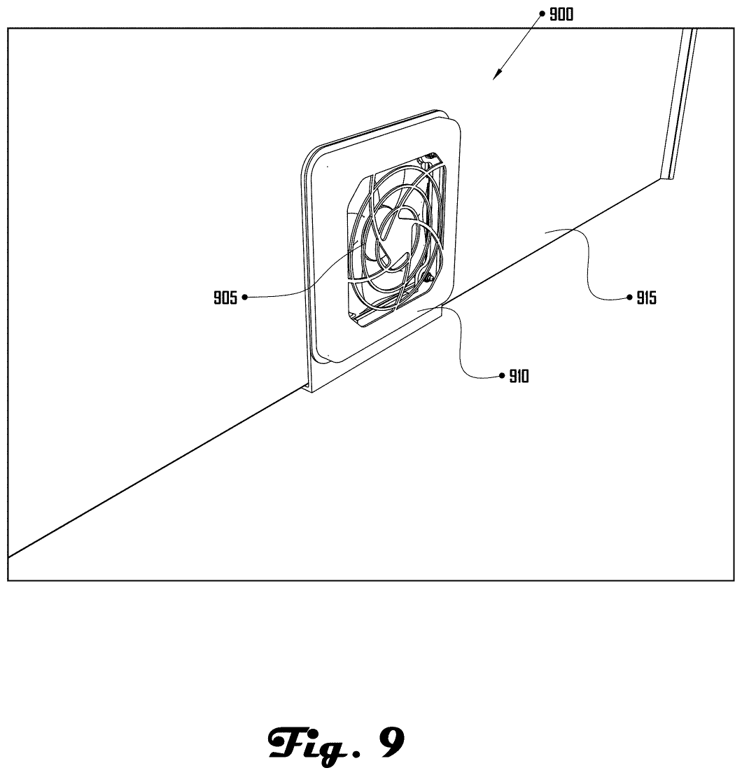

FIG. 9 illustrates an example of air pump and or air vent 900 incorporated with teachings of the present disclosure, according to some embodiments. Air pump and or air vent 900 may comprise an air pump, such as an electric motor and one or more fans, pistons, bellows, or rotary vanes which push air through a passage. The air pump may push air into or out of isolation enclosure 915. Air pump and or air vent 900 may comprise an air filter, such as a HEPA filter, an ozone generator, an ultraviolet light generator, and or an electrostatic generator. Air pump and or air vent 900 may comprise a particle counter sensor to detect and count physical particles, e.g. dust, droplets, and the like. The air pump and particle counter may be coupled to a control system or control module. When the control system detects an error condition of the air pump or another sensor, such as non-operation, operation below a threshold, a temperature condition of the air pump, a temperature condition within an isolation enclosure, or the like, the control system may increase or decrease power to the air pump and or may activate one or more alarms. When the control system detects a particle count from the particle counter sensor in excess of a threshold or a number of particles counted in a period of time, the control system may increase or decrease power to the air pump and or may activate one or more alarms. Isolation enclosure 915 may comprise a plurality of air pump and or air vent 900. The control system may be configured to operate the air pump to push air into or out of isolation enclosure 915. When a person within isolation enclosure 915 is believed to carry an infectious disease, generally when persons exterior to isolation enclosure 915 need to be protected from the infectious disease, the control system may be directed to draw air out of isolation enclosure 915, to pass withdrawn air through a HEPA filter, and to develop a negative relative air pressure within isolation enclosure 915. When the person within isolation enclosure 915 is believed to not carry an infectious disease, such as when the person interior to isolation enclosure 915 needs to be protected from an infectious disease in the exterior environment, the control system may be directed to push air into isolation enclosure 915 through a HEPA filter, and to develop a positive relative air pressure within isolation enclosure 915.

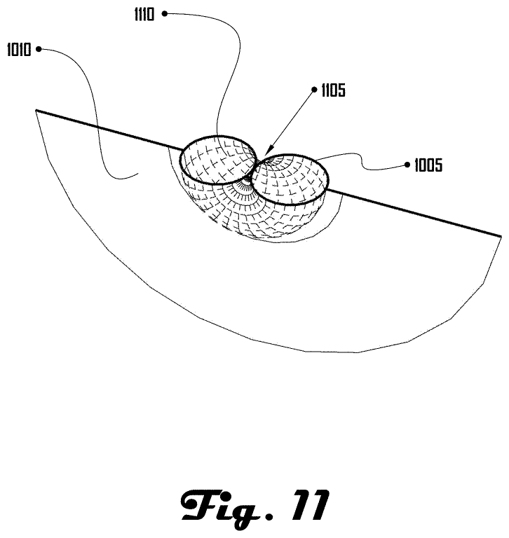

FIG. 10 illustrates an example of access port 1000 into an isolation enclosure incorporated with teachings of the present disclosure, according to some embodiments. FIG. 11 illustrates the example of access port 100 into the isolation enclosure of FIG. 10 with a cross section and incorporated with teachings of the present disclosure, according to some embodiments. Referring to FIG. 10 and FIG. 11, bonded, attached to, or formed in sheet 1010 of an isolation envelope at bond-line 1015 may be toroidal structure 1005. Toroidal structure 1005 comprises passage 1105. Toroidal structure 1005 may be formed of a flexible and/or pliant material, such as those which may be used to form a sheet of an enclosure envelope, as discussed herein. Toroidal structure 1005 comprises interior volume 1110. Interior volume 1110 may be filled with air and pressurized, to thereby close or exert pressure on passage 1105. Passage 1105 may be lined with a fuzzy material, which acts as an air filter. Passage 1105 may thereby allow at least one of a hand, an arm, or a conduit to pass between an interior and an exterior of an enclosure envelope in a repeatable manner.

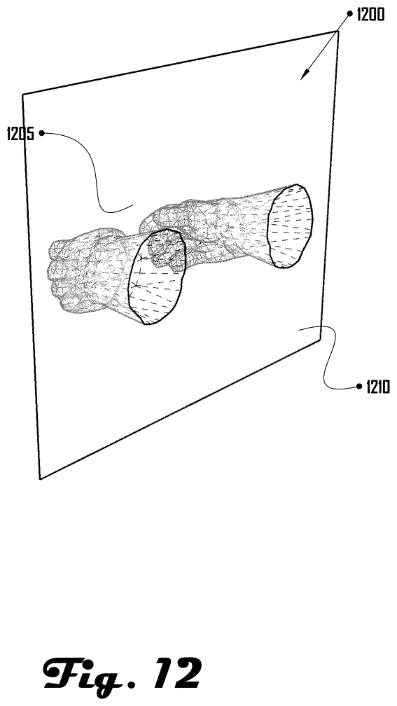

FIG. 12 illustrates an example of flexible glove form 1200 of an isolation enclosure incorporated with teachings of the present disclosure, according to some embodiments. Flexible glove form 1200 may comprise flexible glove 1210. Flexible glove 1210 may be bonded, attached to, or formed in sheet 1205 of an isolation enclosure. Flexible glove 1210 may be reversible. Flexible glove 1210 is illustrated as a glove, though may have a shape of a mitten, a bag, or the like. Flexible glove form 1200 may allow a person within or without of an isolation enclosure to interact with objects on the other side, without opening or penetrating the isolation enclosure.

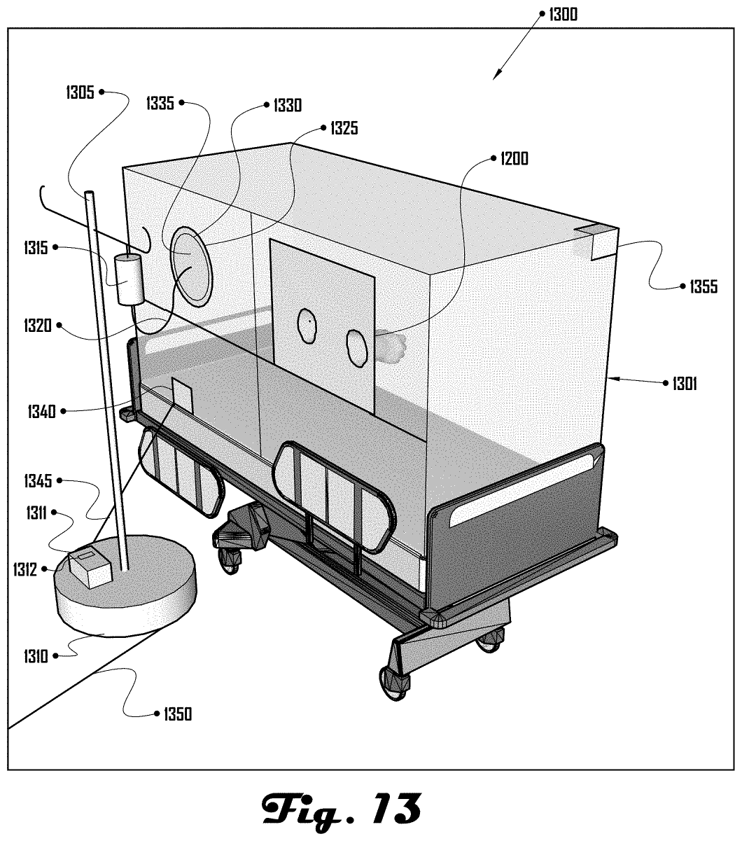

FIG. 13 illustrates an example of a use setting 1300 comprising isolation enclosure 1301, push through airtight connector 1325, power supply 1310, control module 1311, flexible glove form 1200, and sensors 1355 incorporated with teachings of the present disclosure, according to some embodiments. As illustrated in use setting 1300, isolation enclosure 1301 sits on a bed frame and a mattress is within isolation enclosure 1301.

Within a sheet of an isolation envelope of isolation enclosure 1301 may be push through airtight connector 1325, which may also be referred to as a “punch out”. In this example embodiment, push through airtight connector 1325 may be faced on one or both sides by one or more gaskets, such as circular gasket 1330. Gasket 1330 may comprise, for example, an adhesive. Two gaskets may be adhered to one another on opposite sides of the sheet. In a central area of the gasket(s) and adhered between the gaskets may be a seal, such as rubber seal 1335. A conduit or the like, such as intravenous (“IV”) line 1320, may be pushed through the seal.

Within a sheet of an isolation envelope of isolation enclosure 1301 may be flexible glove form 1200, discussed herein.

Solution bag 1315 secured to IV line 1320, may hang from pole 1305. Pole 1305 may be supported in power supply 1310. Power supply 1310 may comprise batteries, transformers, power regulators and the like. Power supply 1310 may be an uninterruptable power supply. Power supply 1310 may connect to an electrical outlet with high voltage power cord 1350 and may comprise one or more low voltage power cord 1345. Low voltage power cord 1345 may provide power to an air pump, such as air pump 1340, to sensors, such as sensors 1355, to an infusion pump, to media devices used by an occupant of the isolation enclosure, and the like.

On top of power supply 1310 is illustrated control system 1311. Control system 1311 may be in a different location. Control system 1311 may comprise control module 1312. Control system 1311 and control module 1312 may be coupled to, for example, air pump 1340, sensors 1355, ultraviolet light emitters, ozone emitters, power supply 1310, and the like. Control module 1311 may be used to activate air pump, to monitor for air pump activity, to monitor sensors, to monitor power supply 1310, and to activate alarms, as discussed herein. Control system 1311 may comprise a computer processor and computer memory. Computer memory in control system 1311 may comprise control module 1312.

1. An isolation enclosure system to isolate a person to reduce transmission of an infectious disease comprising:
a base, a frame, an enclosure envelope;
wherein the base comprises tent structures to secure the base to the frame and wherein the base is formed to fit beneath a mattress;
wherein the tent structures to secure the base to the frame comprise at least one of grommet holes or straps;
wherein the base comprises a drain;
wherein the frame comprises poles;
wherein the enclosure envelope comprises one or more sheets of pliant or flexible material to filter or block passage of an infectious disease agent;
wherein the one or more sheets are shaped to fit within the frame or around the frame;
wherein the one or more sheets comprise fasteners to secure a first of the one or more sheets to a second of the one or more sheets;
wherein the enclosure envelope comprises an opening to allow ingress and egress from the enclosure envelope;
wherein the opening comprises the fasteners; and
further comprising an air pump, an air vent, a sensor, and a control module.

2. The isolation enclosure system according to claim 1, further comprising one or more adjacent enclosure; wherein the base is a first base, the frame is a first frame, the enclosure envelope is a first enclosure envelope, and the opening is a first opening and wherein the adjacent enclosure comprises at least one of second base, a second frame, a second enclosure envelope, and a second opening; wherein the second opening is to be secured to the first enclosure envelope with fasteners; and wherein the second base comprises a second drain.

3. The isolation enclosure system according to claim 2, wherein the first frame is the same as the second frame rotated 90 degrees and the first enclosure envelope is the same as the second enclosure envelope rotated 90 degrees.

4. The isolation enclosure system according to claim 1, wherein the base comprises base sections; wherein the base sections overlap and allow the base to be reduced in size.

5. The isolation enclosure system according to claim 4, wherein at least a portion of the base is flexible to allow the base and isolation enclosure system to bend as the mattress bends.

6. The isolation enclosure system according to claim 1, wherein the poles comprise tent poles and wherein the tent poles of the frame form one or more inverted “U” or “C” structures, one or more cantilevers, and or one or more arches.

7. The isolation enclosure system according to claim 6, wherein a first of the one or more inverted “U” or “C” structures is to be secured to a second of the one or more inverted “U” or “C” structures by a beam; wherein the beam is formed of a flexible material such that when the mattress is to bend the beam is also to bend.

8. The isolation enclosure system according to claim 1, wherein the frame further comprises a wireframe to secure the frame to a ceiling or a structure above the isolation enclosure system.

9. The isolation enclosure system according to claim 1, wherein the one or more sheets of pliant or flexible material comprise at least one of plastic, paper, coated paper, a woven fabric, a filter material.

10. The isolation enclosure system according to claim 1, wherein the one or more sheets are shaped to fit within the frame or around the frame.

11. The isolation enclosure system according to claim 1, wherein the one or more sheets are formed in a tubular shape and are hung on or supported by the frame.

12. The isolation enclosure system according to claim 1, wherein the fasteners comprise at least one or both of a structural fastener and an air-seal fastener.

13. The isolation enclosure system according to claim 12, wherein the structural fastener maintains a structural integrity of the enclosure envelope and wherein the air-seal fastener resists passage of air between the one or more sheets; wherein the structural fastener comprises at least one of a zipper, a lace, or a hook and loop fastener.

14. The isolation enclosure system according to claim 1, wherein the enclosure envelope further comprises at least one of a push through airtight connector, a flexible glove form, or an access port in.

15. The isolation enclosure system according to claim 14, wherein the push through airtight connector is to allow a conduit to be passed through the airtight connector, wherein the flexible glove form is reversible, and wherein the access port comprises a channel formed in a toroid, wherein the toroid comprises an interior volume and a passage; wherein the interior volume is filled with pressurized air to close or exert pressure on the passage; wherein the passage allows at least one of a hand, an arm, or a conduit to pass between an interior and an exterior of the enclosure envelope.

16. The isolation enclosure system according to claim 1, further comprising a high performance air (“HEPA”) filter and wherein the air pump is configured to pump air into or out of the enclosure envelope and wherein air pumped into, out of, or allowed to be released from the isolation enclosure system is to pass through the HEPA filter.

17. The isolation enclosure system according to claim 16, wherein the control module is configured to receive a first signal to pump air out of the isolation enclosure system when an occupant of the isolation enclosure system is believed to be infectious and is configured to receive a second signal to pump air into the isolation enclosure system when the occupant of the isolation enclosure system is believed to not be infectious.

18. The isolation enclosure system according to claim 1, further comprising an uninterruptable power supply, wherein the air pump, the sensor, and the control module are to obtain power from the uninterruptable power supply.

19. The isolation enclosure system according to claim 1, wherein the sensor comprises at least one of an oxygen sensor, a carbon-dioxide sensor, a temperature sensor, or a particle counter sensor; wherein the sensor is to be coupled to the control module and or an alarm; wherein an error condition of the sensor is to cause the control module to trigger an alarm or change an operating parameter of the air pump.

20. The isolation enclosure system according to claim 1, further comprising at least one of an ultra-violet light emitter or an ozone generator to disinfect the enclosure envelope.
